(19) United States
(12) Patent Application Publication
(10) Pub. No.: US 2007/0250900 A1
(43) Pub. Date: Oct. 25, 2007

(54) Media gateway and server

(76) Inventor: Andrew Marcuvitz, Lincoln, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/399,884

(22) Filed: Apr. 7, 2006

(51) Int. Cl. H04N 7/16; H04N 7/173; H04N 7/18

(52) U.S. Cl. 725/141; 725/80; 725/133; 725/153

(57) ABSTRACT

A media gateway/media server (MGMS) distributes video, without impairment, from a variety of sources, over an in-home distribution medium (such as coaxial cable) directly to one or more conventional televisions sets within a house, i.e., without requiring specially adapted hardware, such as a set-top-box, at each television set. One or more peripheral control devices can be used to control the MGMS and select video content to be displayed on the various television sets. The MGMS produces a signal, such as an ATSC, DVB or QAM signal, that the television sets can receive directly, i.e., without additional hardware. In some embodiments, each television set has an associated dedicated channel on the in-home distribution medium, and the MGMS sends video content to a particular television set by modulating the video content onto the channel dedicated to that television set.

### BACKGROUND OF THE INVENTION

The present invention relates to on-premises video distribution systems and, more particularly, to such systems that distribute video program material via a digitally modulated carrier signal.

Many people would prefer to use their television sets to view video material that is stored on, or supplied by, various sources within their houses, such as digital video disc (or digital versatile disc, i.e., DVD) players, cable or satellite television system terminations, personal computers and digital cameras. In addition, the Internet is becoming an important source of video material. However, no known system can distribute video from these sources to one or more conventional television sets scattered throughout a house without impairing the quality of the video or without requiring a set-top-box co-located with each television set.

Cable television (CATV) system operators, direct broadcast satellite (DBS) television system operators and, more recently, telephone companies (collectively hereinafter “carriers”) provide video signals, such as television broadcasts, movies and weather information, to subscribers. As discussed in more detail below, in most situations, a set-top-box is required for each television set to receive these video signals.

To differentiate their service offerings, the carriers offer many services, such as pay-per-view, personal video recorder (PVR), video on demand (VOD) and program guides. For a variety of reasons, television set manufacturers have been slow to integrate these finctions, or hardware or software to support these functions, into television sets. For example, carriers have diverse views about which functions should be offered, thus each carrier offers a different combination of features and functions, and television set manufacturers cannot anticipate to which carrier's system a given television set will be connected. Thus, it is difficult for television set manufacturers to include all the functions, hardware and software that would be required in television sets to support all the possible features that carriers offer or will offer in the future. Furthermore, many modem finctions, such as PVR, require expensive hardware, which manufacturers are reluctant to include in television sets, because doing so would raise the prices of the sets.

Consequently, to fully benefit from the service offerings of the carriers, most television sets must be connected to carrier systems through set-top-boxes. Even “cable-ready” television sets typically require set-top-boxes to receive “premium” programming. Some recently introduced television sets accept CableCARD plug-in circuit boards, which act as a form of set-top-box and, thus, enable the television sets to receive premium programming. However, presently such television sets cannot receive pay-per-view programming or access other advanced features without traditional set-top-boxes. In most cases, only an over-the-air broadcast can be fully exploited by a television set without a set-top-box.

In addition, the number of possible video sources continues to increase. For example, video is available from video cassette recorders (VCRs), DVD players, digital still and movie cameras, home computers and the Internet, as well as from carrier terminations. Accepting video signals from, and switching among, these various sources requires many expensive connectors (jacks) on a television set or a separate switching box. In either case, the source devices are generally dedicated to their respective television sets. That is, each source device is co-located with its associated television set. Consequently, many multi-television set homes have duplicate video source hardware, such as a DVD player for each television.

The sizes and number of the video sources pose problems. For example, a set-top-box or DVD player can be larger than a small television set used in a kitchen. Thus, many viewers find it frustrating to have to either clutter a kitchen counter with all the hardware necessary to be able to view a variety of video sources on the kitchen television set or dispense with the video sources and view only over-the-air broadcasts.

Some high-end media installations include centralized video sources that distribute video signals over dedicated cables to display screens or video projectors located in various locations within a house. However, these centralized distribution systems require extensive cabling, which is often impractical.

Some recently developed devices distribute video from a variety of sources over a wireless packet-switched computer network to one or more television sets that are specially equipped to connect to the wireless network. However, such devices are not compatible with most of the installed base of television sets.

In addition, the fastest growing source of video, i.e. the Internet, is not readily accessible with a conventional television set. Although a personal computer can be used to download and view video from the Internet, many viewers would prefer to view such material on their television sets. Generally, an environment where a user uses a computer, such as a home office, is not conducive to viewing video material that is more than a few minutes long.

Many viewers have installed high-definition, large-screen television sets in rooms with comfortable chairs, etc., to create appropriate environments (“media rooms”) for spending hours being entertained. These viewers would prefer to watch video material, such as video material downloaded from the Internet, in their media rooms. However, transferring video material from a personal computer located elsewhere in a house to a television set is cumbersome. Furthermore, media rooms are typically well appointed and attractively decorated. Consequently, many viewers would prefer not to clutter their media rooms with unsightly local computers, such as Media Center PCs, and their attendant noisy fans, etc.

Of all the equipment involved in sourcing and displaying video material, i.e., DVD players, computers, set-top-boxes, television sets, etc., the television sets are typically the most expensive and have the longest useful lives. Viewers replace television sets less frequently than most other equipment. Thus, there is a large installed base of television sets that will not be replaced soon. However, viewers would prefer to be able to view video from many sources, especially their personal computers and the Internet, on their television sets. There is, therefore, a need for a system for distributing video, without impairment, from a variety of sources to one or more conventional televisions sets within a house, without requiring a set-top-box at each television set or the duplication of functions or content at each viewing location.

### BRIEF SUMMARY OF THE INVENTION

The present invention provides a media gateway/media server (MGMS) that distributes video, without impairment, from a variety of sources, over an in-home distribution medium (such as coaxial cable) directly to one or more conventional televisions sets within a house, i.e., without requiring specially adapted hardware, such as a set-top-box, at each television set. One or more peripheral control devices can be used to control the MGMS and select video content to be displayed on the various television sets. The MGMS produces a signal, such as an Advanced Television Systems Committee (ATSC), Digital Video Broadcasting (DVB), quadrature amplitude modulation (QAM) or Integrated Services Digital Broadcasting (ISDB) signal, that the television sets can receive without additional hardware. In some embodiments, each television set has an associated dedicated channel on the in-home distribution medium, and the MGMS sends video content to a particular television set by modulating the video content onto the channel dedicated to that television set.

These and other features, advantages, aspects and embodiments of the present invention will become more apparent to those skilled in the art from the Detailed Description Of The Invention that follows, in conjunction with the Drawings.

### BRIEF DESCRIPTION OF THE SEVERAL VIEWS OF THE DRAWINGS

FIG. 1 is a block diagram showing a context in which a media gateway/media server (MGMS) can be used, in accordance with the present invention;

FIGS. 2A and 2B form a detailed block diagram of one embodiment of the MGMS of FIG. 1, in accordance with the present invention;

FIG. 3 is a block diagram of a portion of an alternative MGMS of FIGS. 1 and 2A and 2B, in accordance with the present invention; and

FIG. 4 is a block diagram of a portion of another alternative MGMS of FIGS. 1, 2A, 2B and 3.

### DETAILED DESCRIPTION OF THE INVENTION

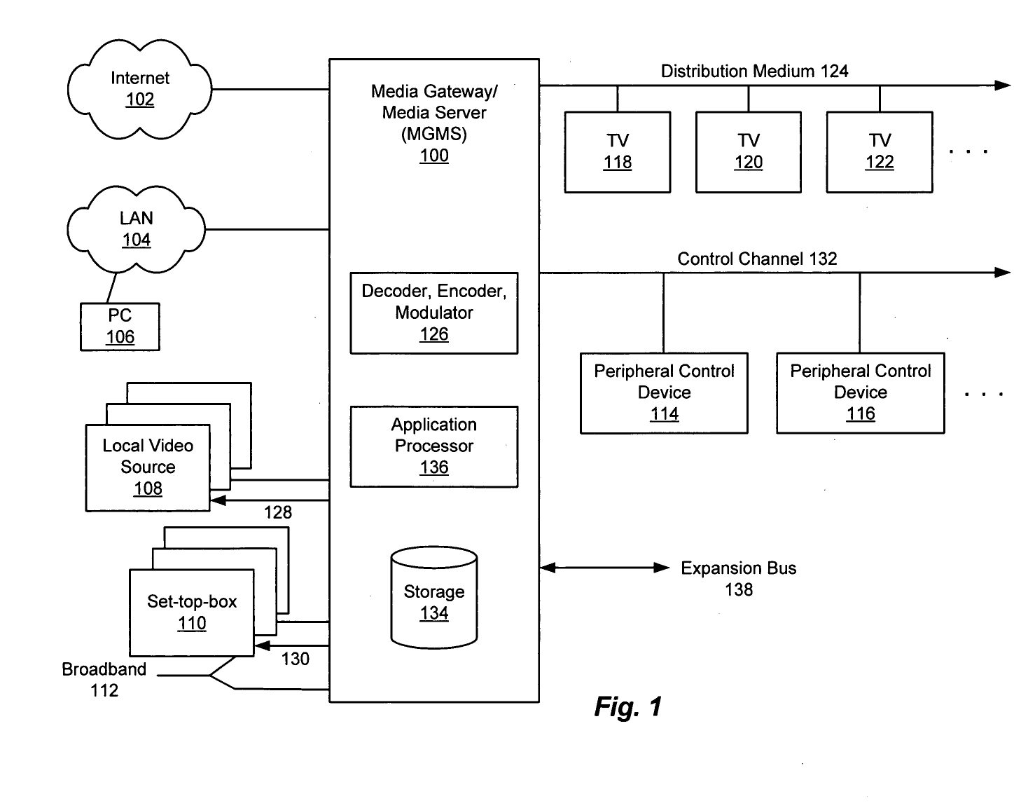

Disclosed herein are apparatus and methods for distributing video, without impairment, from one or more sources, to one or more conventional televisions sets within a premises, such as a house. The video is distributed directly to the television sets, i.e., without requiring specially adapted hardware, such as a set-top-box, at each television set. FIG. 1 is a block diagram showing a context in which a centralized media gateway/media server (MGMS) 100 receives video from one or more sources 102, 104, 106, 108, 110 or 112 and, in response to commands from a peripheral control device 114 or 116, etc., distributes the video (or separately selected portions thereof) to each of a selected one or more of a plurality of conventional television sets 118, 120, 122, etc., over an in-home distribution medium 124. The MGMS 100 can also serve video that is stored in and/or generated by the MGMS 100. For example, the MGMS 100 can serve recorded programs and content guides to the television sets 118-122. The distribution medium 124 can be wire, such as home coaxial cable, or wireless, such as via a low-power in-home transmitter.

The MGMS 100 uses the distribution medium 124 and a carrier modulation technique that convey the video without impairment, but that are compatible with the conventional television sets 118-122. For example, conventional television sets are equipped to receive digital signals according to various standards, such as Advanced Television Systems Committee (ATSC), Digital Video Broadcasting (DVB), quadrature amplitude modulation (QAM) and/or Integrated Services Digital Broadcasting (ISDB). Thus, the MGMS 100 can deliver unimpaired video to the television sets 118-122 using one or more of these types of signals or other types of signals that the television sets 118-122 are equipped to receive directly, i.e., without a set-top-box.

Stated briefly, the MGMS 100 encodes (if necessary) and digitally modulates (or re-encodes and/or re-modulates, as the case may be) a carrier with video information that is to be displayed on one or more of the television sets 118-122. The MGMS 100 includes decoder, encoder and/or modulator resources 126 to perform these functions and generate digitally modulated signals that the MGMS 100 distributes over the distribution medium 124. Thus, the MGMS 100 receives or generates video contents. The MGMS 100 stores, processes and/or transforms the video and simultaneously transmits the video contents to one or more television sets 118-122 without intervening set-top-boxes in response to instructions (commands) the MGMS 100 receives from peripheral control devices 114-116. In addition, the MGMS 100 sends information about the video contents to the peripheral control devices 114-116.

The MGMS 100 reserves one or more channels of the distribution medium 124 for distributing the video to the television sets 118-122. In one mode of operation, each television set 118-122 is associated with a different one of the reserved channels, and each television set remains tuned to its associated channel. The MGMS 100 sends video to each television set 118-122 over the channel associated with that television set. Two or more of the television sets 118-122 (such as a television set in a kitchen and another television set in a near by family room) can be treated as a single set and display identical video by associating and tuning both of the television sets to a single channel. In this case, the two or more television sets 118-122 will respond identically to remote control commands.

The video provided by the MGMS 100 to the television sets 118-122 can be acquired by the MGMS 100 from any of a variety of sources 102-112. For example, the MGMS 100 can fetch video stored on one or more servers (not shown) connected to the Internet 102. Similarly, the MGMS 100 can fetch video stored on a PC 106 connected to the MGMS 100 via a local area network (LAN) 104. One or more local video sources 108, such as a digital video recorder (DVR), DVD player, VCR, video camera or personal computer, can be directly connected to the MGMS 100. Each of the video sources 102-110 is connected to the MGMS 100 via a video input port, however some of these ports can be digital video ports, analog video input ports and/or computer network ports. Thus, depending on its type, a video input port can carry one or more than one simultaneous “program” of video content. For example, multiple video files can be sent simultaneously over a single computer network port, such as an Ethernet port, and multiple channels are simultaneously available over a CATV connection.

If a local video source 108 can be remotely controlled, the MGMS 100 controls the local video source 108 via a control link 128, such as an infra red (IR) link or a wired link. Similarly, a set-top-box 110 of a broadband service 112, such as a cable television (CATV) system, direct broadcast satellite (DBS) system or telephone carrier, can be connected to the MGMS 100. If the set-top-box 110 can be remotely controlled, the MGMS controls the set-top-box 110 via a control link 130.

If video from one of the sources 102-112 is already modulated in a way that the television set(s) 118-122 can receive without additional hardware, the MGMS 100 may pass the received modulated signal through to the television set(s), without re-encoding or re-modulating the video signal. For example, CATV broadband service 112 and over-the-air terrestrial broadcast television (from an antenna) are channelized signals that are, in some cases, digitally modulated. The MGMS 100 passes these signals through to the distribution medium 124 without processing the signals, and the television sets 118-122 receive these signals by tuning to a desired channel conventionally. Optionally, one or more of the television sets 118-122 can have set-top-boxes (not shown) to receive CATV, DBS, etc. signals distributed over the distribution medium 124, although as discussed below, the MGMS 100 can eliminate the need for such set-top-boxes.

The peripheral control devices 114, 116, etc. communicate with the MGMS 100 via a control channel 132, such as a wireless local area network (LAN). There need not be a one-to-one relationship between the television sets 118-122 and the peripheral control devices 114116. That is, one peripheral control device 114 or 116 can be used to control video material sent by the MGMS 100 to several television sets 118-122 (including sending different video material to each of the television sets), or multiple peripheral control devices 114 and 116 can control the video material sent by the MGMS 100 to one of the television sets 118-122.

Optionally, the MGMS 100 includes a mass storage device 134 for storing video received from one of the sources 102-112 or from another source or internally generated by the MGMS 100. Alternatively, an external mass storage device (not shown) can be connected to, and controlled by, an external computer (not shown) and accessed by the MGMS 100 via a computer network. Responsive to a command from one of the peripheral control devices 114 or 116 or a command received from another source, such as a computer on the LAN 104 or on the Internet 102, the MGMS 100 sends all or part of the video stored on the mass storage device 134 (or an external mass storage device) to a selected one or more of the television sets 118-122.

Optionally, the MGMS 100 includes an application processor 136 for executing application programs. For example, these application programs can process video content or locate, select, purchase, manage, edit, record, generate or store video or assist in these or other functions. Specific examples include a personal video recorder (PVR), channel guide, video game and video conference application. In addition, the MGMS 100 can include built-in video content generating devices, such as a DVD juke box (not shown). The application processor 136 can be a processor dedicated to executing application programs, or it can be the same as, or one of, the processor(s) in the MGMS 100 that perform other functions described herein.

Also optionally, the MGMS 100 includes an expansion bus 138 for attaching optional hardware, such as additional processing and memory resources to enable the MGMS 100 to execute application programs. Regardless of whether the application programs are executed by the application processor 136 or a processor connected to the expansion bus 138, the application programs can be stored in the MGMS 100, or the application programs can be stored externally, such as on a memory card or on a computer connected to the LAN 104 or to the Internet 102. In addition, other video source devices, such as a DVD player or jukebox, can be connected to the expansion bus 138.

As noted, the MGMS 100 generates digital signals according to one or more standards. Each of these standards specifies an encoding scheme and a modulation scheme. For example, ATSC specifies that video content is encoded according to the Moving Picture Experts Group 2 (MPEG-2) encoding and encapsulation standard. ATSC also specifies that the MPEG-2 encoded video (or data) stream is transmitted using vestigial sideband (VSB) modulation. Typically, 8-level VSB (8-VSB) is used for over-the-air broadcasts, whereas 16-level VSB (16-VSB) is used in CATV systems, due to the higher signal-to-noise ratio provided by CATV systems.

8-VSB and 16-VSB are examples of digital modulation techniques that include error correction. Thus, when an 8-VSB signal is received, the receiver can generally completely reconstruct the original data stream, even in the face of channel impairments, such as multi-path signals and fading, and the resulting video image is not generally degraded from the original video image (producing a “perfect picture”). If, however, the signal is so impaired that it contains insufficient information to reconstruct the original data stream to a predetermined level, the receiver provides nothing (a blank screen). Consequently, digital signals can be stored, sent, re-modulated and processed by a series of nodes, without impairing the quality of the resulting video images.

The other digital television standards, i.e., DVB, QAM, ISDB, etc., also have variants and share the “perfect picture” qualities of ATSC. For example, DVB-S and DVB-S2 are used in satellite systems; DVB-C is used in cable television systems; DVB-T is used for terrestrial (over-the-air) television broadcasts; and DVB-H is used for terrestrial television on handheld devices. DVB-T uses Coded Orthogonal Frequency Division Multiplexing (CODFM) to encode video content. The term “QAM” is commonly used to describe a digital television standard used by many cable television systems. In that context, QAM includes encoding. However, the term “QAM” can also refer to just a modulation technique. For example, DVB-C uses QAM modulation, generally 64-QAM or 256-QAM, although other numbers of constellation points can also be used.

In contrast to digital television, earlier “analog” television standards, such as National Television System Committee (NTSC), specify analog modulation, such as amplitude modulation (AM) for video information and frequency modulation (FM) for audio information. Analog television signals are subject to degradation by the channel over which they are carried, and the modulation, demodulation and processing performed on these signals necessarily lead to imperfect results, even when these signals are carried over relatively short coaxial cables or relatively low-noise wireless channels. Thus, sending an analog television signal necessarily impairs video material.

NTSC has been adopted for use in North America and western portions of South America. In other parts of the world, other analog standards are used, including phase-alternating line (PAL) and sequential couleur avec memoire (French for “sequential color with memory” or SECAM). Signals generated according to these analog standards suffer the same degradation as NTSC signals.

Embodiments of the present invention generate one or more digital television signals. Which particular type of digital television signal or standard is used is not important, as long as the intended receiving television set can receive the digital signals without a set-top-box or other hardware specialized for converting digital television signals to signals that the television receiver can receive and process.

Cable Television (CATV) and Other Broadband Television Systems Background

Cable television (CATV) systems typically send a variety of video material simultaneously via a plurality of digital and/or analog channels over one or a small number of coaxial and/or fiber-optic cables. Typically, the channels that are digitally modulated are done so according to ATSC (with 16-VSB) or according to 16-QAM or 256-QAM. A set-top-box selects one of the channels (based on user input, such as via a remote control), demodulates and decodes the signal from the selected channel and provides the selected channel's content to a television set for display. Depending on the input capabilities of the television set, the set-top-box provides the content via a re-modulated video signal, a baseband video signal or a (typically uncompressed) digital video signal.

If a television set does not accept baseband video signals (or the viewer chooses not to use the television's baseband video input capabilities), the set-top-box re-modulates the video signal onto a fixed television channel according to an analog television standard and provides the re-modulated signal to the television set via a dedicated coaxial cable. The television set tuner receives the re-modulated video signal,. demodulates the signal and displays the video. Using analog modulated signals and a coaxial cable to distribute the signals allows the set-top-box to be located in a different part of a house than the television set. However, as noted, all analog modulated signals are subject to degradation (impairment). Thus, the quality of the viewed image is limited.

To overcome this problem, many set-top-boxes provide baseband video signals or digital video signals to television monitors and television sets with direct video inputs. (Television monitors have direct video inputs, but do not include tuners.) Examples of baseband video signals include composite video, S-video and component video (R/G/B or Y/Cr/Cb) signals. Examples of digital video signals include signals produced according to various standards, such as Digital Visual Interface (DVI) and High Definition Multimedia Interface (HDMI). DVI and HDMI signals are uncompressed digital signals, although, alternatively, compressed video signals could be sent to a television that is capable of decompressing the signals.

However, these baseband or digital set-top-box outputs can carry only a single channel of programming at a time, and they require dedicated cabling between the set-top-box and the destination television set or monitor. In addition, each of these types of outputs has length limitations on the cable(s) that carry the signals from the set-top-box to the television.

### Media Gateway/Media Server

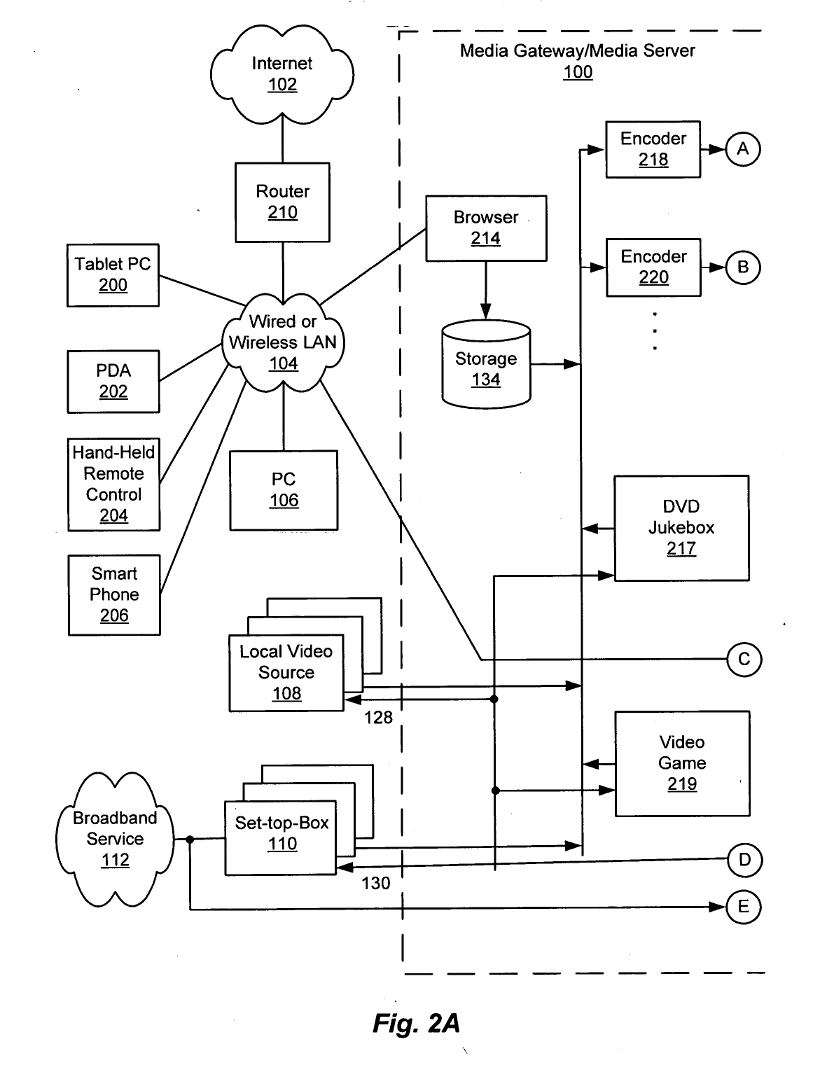

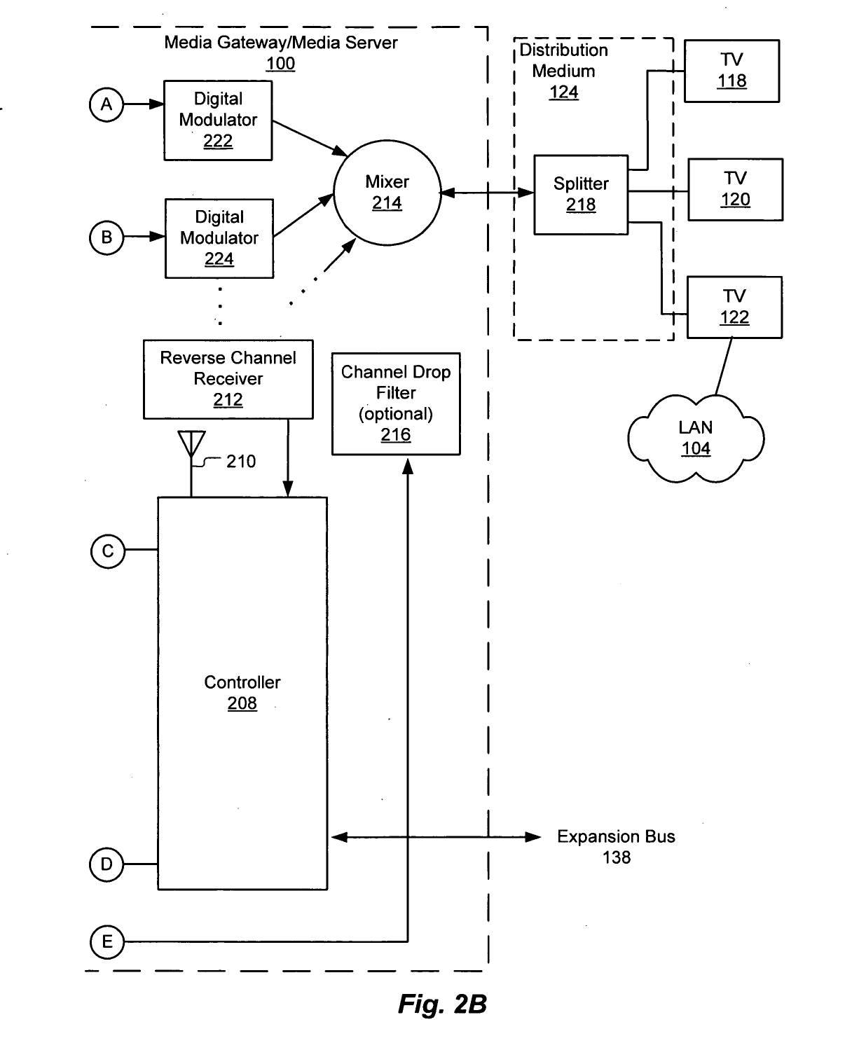

FIGS. 2A and 2B depict a functional block diagram of the MGMS 100, in accordance with one embodiment of the disclosed invention. As noted, the MGMS 100 receives video signals from a variety of sources 102-112 and distributes these video signals directly to one or more television sets 118-122. As needed, the MGMS 100 modulates or re-modulates these video signals in a way that enables the television sets 118-122 to receive these signals without set-top-boxes or other additional hardware connected to the television sets. Operation of the MGMS 100 is controlled by a controller (which may be one or more processors), which receives commands from one or more peripheral control devices 114, 116 (FIG.1). It should be noted that some embodiments include subsets of the components shown in FIGS. 2A and 2B, as discussed below. In addition, the MGMS 100 need not be connected to all of the video sources shown. For example, some embodiments do not include connections to broadband sources 112 or to any external video sources.

One or more peripheral control devices 114, 116 (FIG.1) are used to select video content to be displayed on the television sets 118-122 and (optionally) to generate instructions for an application program being executed by the MGMS 100. A peripheral control device can be a tablet PC 200 (FIG. 2A), wired or wireless person digital assistant (PDA) 202, hand-held remote control 204, “smart phone” 206 or other suitable device that can send remote control signals or commands (collectively hereinafter “commands” or “remote control commands”) to the MGMS 100. The remote control commands can be sent by any suitable mechanism, such as infrared light, radio frequency (RF) wireless transmission, local or wide area network connection, ultrasonic sound and/or wired circuit.

For example, the tablet PC 200 executes a suitable application program to communicate with a controller 208 (described in more detail below) in the MGMS 100 via a wired or wireless local area computer network (LAN) 104. In another example, the smart phone 206 establishes a wireless Internet protocol (IP) connection through a wireless service provider (not shown) to the Internet 102 and, through a router 210, to the MGSM 100. Alternatively, the smart phone 206 or another telephone can place a telephone call through the public switched telephone network (PSTN), public land mobile network (PLMN) or other telephone system to the MGMS 100 to control the MGMS 100 or an application program being executed by the MGMS 100. In yet another example, the hand-held peripheral control 204 communicates directly with the MGMS 100 via a wireless radio frequency (RF) link. In this case, the MGMS 100 includes an RF receiver 210 and, optionally, an RF transmitter to send signals to the hand-held peripheral control 204, as discussed in more detail below.

The remote control commands can also be sent via a combination of networks and/or devices. For example, the hand-held peripheral control device 204 can send infrared signals to one of the television sets 122, and the television set 122 can relay the commands to the MGMS 100 via the LAN 104 or via a reverse channel over the distribution medium 124. In this case, a reverse channel receiver 212 receives the reverse channel commands and forwards them to the controller 208.

As noted, the MGMS 100 can be connected to receive video content from any suitable source device or combination of devices. Exemplary sources include servers (not shown) on the Internet 102, in-home computers, such as a server (not shown) or PC 106, on the LAN 104, local video sources 108, such as PVRs, and one or more set-top-boxes 110.

For example, to obtain video from the Internet 102, the controller 208, executes an application program (such as a browser or search engine (collectively hereinafter “browser 214”)) stored in a memory (not shown). The browser 214 can be programmed to search the Internet 102 for video content matching user-specified criteria, such as keywords, uniform resource locators (URLs), favorite authors and/or directors, studios, etc. If the browser 214 locates appropriate video files, the browser 214 downloads the video files and/or descriptions thereof to the storage device 134. Similarly, the controller 208 can be programmed to download pre-specified video content according to a predetermined schedule.

Similarly, the browser 214 can search the LAN 104 for suitable video files. If suitable video files are accessible from a local computer, such as the PC 106, via a high-speed connection, such as the LAN 104, the browser 214 can avoid making a copy of the video files on the storage device 134. Instead, the controller 208 simply stores URLs or other identifiers of the video files. Then, when the video files are needed, the controller causes the video files to be sent (such as via file transfer or by streaming the file) from the computer on the LAN 104 to the MGMS 100.

A user can interactively use the browser 214 to manually browse available video on the Internet 102 or the LAN 104. If the user finds a video file of interest, the user instructs the browser 214 to download the file to the storage device 134. To support manual browsing, one of the peripheral control devices 200-206 serves as a user input device, and a screen on the peripheral control device 200-260 or one of the television sets 118-122 serves as a display. In this regard, a peripheral control device with a full keyboard, such as the tablet PC 200 or wireless PDA 202, is well suited for interacting with the application program.

The controller 208 stores the downloaded video files or identifiers thereof and/or their corresponding descriptions in the mass storage device 134 for later viewing or perusal. As noted, the storage device 134 can be internal to the MGMS 100, or the storage device 134 can be connected to, and controlled by, an external computer, such as the personal computer 106 or a computer connected to the Internet 102. In this case, the MGMS 100 accesses the video via the LAN 106 or the Internet 102.

Optionally, the MGMS 100 includes a program guide application program for displaying information about video content stored on the LAN 104, Internet 102 or mass storage device 134. The program guide can be implemented by software executed by the controller 208. The controller 218 displays results of the program guide on a selected one or more of the television sets 118-122 or one of the peripheral control devices 200-206, in response to commands from a peripheral control device 200-206. As a result of viewing the program guide, a user can select one or more of the video files stored on the LAN 104, Internet 102 or the storage device 134 for display on a selected one or more of the television sets 118-122. As described in more detail below, the MGMS 100 causes the selected video contents to be encoded (if necessary) and digitally modulated onto the channel associated with the selected television set(s) 118-122 and then provided to the television set via the distribution medium 124.

Optionally, a user can establish a set of preferences or an absolute schedule, and the controller 208 can send one or a series of video files from one or more of the video sources 102-112 or the storage device 134 to the user's television set 118-122. The preferences or schedule are stored in the mass storage device 134 or other suitable memory. For example, if the user enjoys watching science fiction material, historical documentaries and gardening programs, the user specifies selection criteria describing suitable video material, and the controller 208 gathers video files that match the user's selection criteria. Later, when the user wishes to be entertained, the user instructs the MGMS 100 to begin displaying the gathered video files, and the controller 208 causes one of the gathered video files at a time to be displayed on the user's television set.

The user need not interact with the system at the end of each video file, because, absent a contrary command from the user, the MGMS 100 displays the next video file in the gathered set. Thus, the user can watch a series of gathered science fiction video files. Alternatively, the user may have specified that the MGMS 100 should randomize the genres to be displayed. In this case, the MGMS 100 intermixes the three types of program material (science fiction, documentaries and gardening), and the user is presented with one “program” after the other, much the way a CATV channel or over-the-air channel presents one program after the other.

The MGMS 100 also receives video contents from local video sources 108, such as DVD players, personal computers, digital cameras, etc. These local video sources 108 are directly connected to the MGMS 100, and they can provide the video in any combination of appropriate analog and/or digital formats, such as composite video, S-video, component video (R/G/B or Y/Cr/Cb), DVI, HDMI or a digitally encoded form, such as MPEG-4.

The controller 208 can also control the local video sources 108. For example, the MGMS 100 includes infrared, radio frequency (RF), wired or other control links 128, by which the controller 208 can send signals to the various local video sources 108. In one example, the MGMS 100 includes an infrared sender for each local video source 108, and the controller 208 causes signals to be sent by the infrared sender, similar to signals that would be sent by a remote control device associated with the local video source 108. Some local video source 108 devices (including some set-top-boxes) include jacks, by which the devices can accept electronic signals and, thereby, be remotely controlled. In any case, via the control link 128, the controller 208 can cause the local video source 108 to play, rewind, pause, select video content, etc., as appropriate for the particular local video source device.

The MGMS 100 accepts remote control commands from the peripheral control devices 200-206, such from a user to select video content to be displayed on one of the television sets 118-122. As appropriate, the controller 208 generates and sends remote control commands to the local video sources 108 via the control links 128 to cause the local video sources to provide the required video contents. Additionally, the controller can simply pass commands from the peripheral control devices 200-206 through to the local video sources 108. For example, a user can use one of the peripheral control devices 200-106 to program a personal video recorder (PVR) (i.e., one of the local video sources 108) to record a television program at a particular time.

If a local video source 108 is capable of outputting status information, etc. to a remote control or other device, the controller 208 accepts this information and makes it available to suitably configured ones of the peripheral control devices 200-206. For example, if a DVD player sends information about the length of the currently selected video content, the controller 208 forwards that information to the peripheral control device 200-206 for display. Devices, such as the tablet PC 200 and the wireless PDA 202, execute an application program that simulates a remote control device, including accepting commands from a user and sending the commands to the controller 208 for forwarding to the appropriate local video source 108. Similarly, the peripheral control device 200-206 displays information sent by the controller 208, such as information forwarded from a local video source 108.

One or more set-top-boxes 110 that terminate drops from respective broadband service providers (carriers) can also be connected to the MGMS 100 . The set-top-box 110 can terminate an RF broadband service 112, such as CATV or DBS, or a packetized broadband service 112, such as a service provided by a telephone carrier. Each set-top-box 110 is treated much the same way the local video sources 108 are treated. That is, each set-top-box 110 provides a digital or analog video output that is connected to the MGMS 100, and the controller 208 controls the set-top-box 110 to select a CATV, DBS or other channel. The MGMS 100 modulates (re-modulates) the video content provided by the set-top-box 110 onto the reserved channel that is associated with the television set 118-122 on which the content is to be displayed.

Alternatively or in addition, an RF broadband drop 112 or an over-the-air broadcast reception antenna (not shown) (collectively referred to as a broadband service 112) can be directly connected to the MGMS 100. In this case, signals from the broadband service 112 are combined by a mixer 214 with the digitally modulated signals produced by the MGMS 100, and the resulting signals are provided to the television sets 118-122 via the distribution medium 124. The television sets 118-122 can tune to channels of the broadband service 112, either directly (if the television sets are “cable ready” or otherwise capable of receiving the channels of the broadband service 112) or via set-top-boxes (not shown) that are co-located with the television sets 118-122. If necessary, a channel drop filter 216 blocks selected channels of the broadband service 112, to reserve these channels for use by the MGMS 100 . Otherwise, the MGMS 100 simply passes the broadband signals through to the distribution medium 124 without processing the signals.

The MGMS 100 can generate video content. For example, the MGMS 100 can include a DVD jukebox 217, video game 219 or other internal video content generator. As discussed above, commands from a peripheral control device 200-206 are used to select video content from one of the internal video content generators and direct the generated video to one or more of the television sets 118-122. The peripheral control device 200-206 can also be used to interact with the internal video content generator. For example, the tablet PC 200 or a peripheral device (ex., keyboard, mouse, joystick, etc.) connected thereto can be used as an input device for the video game 219 or to select content on the DVD jukebox 217. An internal video content generator is optional. However, some embodiments of the MGMS 100 have internal video content generators and do not connect to any external video sources.

As noted, the MGMS 100 produces a digitally modulated signal on a channel associated with one or more of the television sets 118-122 to deliver video contents to the associated television set(s). In response to a command from one of the peripheral control devices 200-206, or at a pre-programmed time, the controller 208 causes video contents from one of the video sources 102-110 or from the storage device 134 to be encoded (if necessary), digitally modulated and sent via the distribution medium 124 to the television set(s) 118-122.

The MGMS 100 includes one or more encoders 218, 220, etc. to encode or transcode (as needed) the video signal received from the video source 102-110. The controller 208 switches in or switches out the encoder 218, 220, etc., and otherwise controls the encoder, as needed. That is, if the video signal from a given video source 102-110 is already appropriately encoded for the intended receiving television set 118-122, the controller 208 switches the encoder out of the signal path between the video source 102-110 and a modulator (described below) or causes the encoder to simply pass the signal through. If the video signal from the video source is already encoded, but not according to the appropriate encoding technique, the controller 208 switches an appropriate transcoder (not shown) into the signal path or controls the encoder 218, 220, etc. to perform an appropriate transcoding. (In this latter case, the encoder 218, 220, etc. is deemed to be a transcoder.)

Although the encoders 218, 220, etc. are shown in FIG. 2A as discrete blocks, the encoding for one or more video streams can be performed by one or more processors executing suitable instructions. The processor(s) can be dedicated to encoding, or they can also perform other finctions.

The MGMS 100 also includes one or more digital modulators 222, 224, etc. to digitally modulate the encoded video contents. Each digital modulator 222, 224, etc. modulates a video signal onto a different one of the reserved channels. In one embodiment, the digital modulators 222, 224, etc. are modular, so a user can install as many digital modulators as there are television sets 118-122, or the user can install as many digital modulators 222, 224, etc. as would be required to simultaneously send a desired number of different content channels over the distribution medium 124. In other embodiments, the number of digital modulators 222, 224, etc. is fixed, for example based on the maximum number of simultaneous content channels desired.

In one embodiment, each modulator 222, 224, etc. operates on a fixed one of the reserved channels. In this case, the controller 208 responds to a need to display particular video contents on a particular television set 118-122 by causing the video contents to be routed from the appropriate video source 102-110, through an appropriate encoder (if necessary), to the modulator 222, 224, etc. that modulates on the reserved channel associated with the particular television set 118-122.

In another embodiment, the channels on which the modulators 222, 224, etc. operate are adjustable, and the controller 208 selects one of the modulators 222, 224, etc. and commands the modulator to operate on the channel associated with the television set.

In yet another embodiment, the channels on which the modulators 222, 224, etc. operate are either fixed or adjustable, but channels are not permanently associated with television sets 118-122. Instead, when particular video contents are to be displayed on a particular television set 118-122, the controller 208 selects an available modulator 222, 224, etc. and an available channel and commands the modulator to operate on the selected channel. The controller 208 instructs the user, such as through one of the peripheral control devices 200-206, to tune the television set 118-122 to the selected channel.

The specific encoding technique used by the encoders 218, 220, etc. and the specific digital modulation technique used by the modulators 222, 224, etc. depend on the capabilities of the television sets 118-122. For example, most modem television sets in the United States are capable of receiving digital television signals encoded and modulated according to ATSC (with either 8-VSB or 16-VSB).

The MGMS 100 can use a combination of encoding and modulation techniques to deliver the video to the television sets 118-122. For example, the MGMS 100 can deliver some video to some of the television sets 118-122 via an ATSC signal, and the MGMS 100 can deliver other video to other of the television sets 118-122 via a QAM signal. Optionally, the choice of encoding and/or modulation technique is a user-configurable option.

The mixer 214 combines the outputs of the digital modulators 222, 224, etc. (and optionally the RF broadband signal 112) to provide an output. Depending on the medium used to carry the channels from the MGMS 100 to the television sets 118-122, a splitter 218 may be needed. For example, if coaxial cable is used in a house to deliver signals to more than one television set 118-122, the splitter 218 is typically needed to distribute the signal among multiple coaxial cable segments while maintaining proper cable impedance.

One or more low-power transmitters and antennas (not shown) can be used instead of, or in addition to, an in-house coaxial cable to wirelessly distribute video signals from the MGMS 100 to one or more of the television sets 118-122. The transmitter(s) is (are) configured to transmit on one or more frequencies that the television sets 118-122 can receive.

In one embodiment, each transmitter transmits all the channels provided by the mixer 214. The transmitter power is low enough, and optionally adjustable, so the radiated signal does not reach substantially beyond the boundaries of the premises. This embodiment can broadcast the channels provided by the mixer 214 to a plurality of television sets and/or to one or more portable television sets that may be moved within the broadcast range of the transmitter.

In another embodiment, each transmitter is intended to send a wireless signal over a relatively small distance, such as about one meter, to one of the television sets 118-122. The transmitter transmits one or all the channels provided by the mixer 214. The transmitter power is low enough (typically lower than in the first wireless embodiment), and optionally adjustable, so the radiated signal does not reach substantially beyond the one television set. Optionally, several of these low-power transmitters can be used in a single premises. For example, each transmitter can be associated with a different one of the television sets 118-122.

The transmitter(s) and/or connectors to connect to the coaxial cable are collectively referred to herein as a “premises media port.”

The MGMS 100 also provides a platform for other application programs to be executed by the controller 208 or other processor(s) (not shown). Examples of such application programs include video conference and video editing programs to edit video contents stored on the mass storage device 134 or elsewhere, such as on the personal computer 106 connected to the LAN 104. In a video conference application, one of the peripheral control device, such as the tablet PC 200, includes a video camera. Images from the video camera are sent by the tablet PC 200, via the LAN 104, to the MGMS 100. The MGMS 100 forward the images, via the Internet 102 to a video conference server (not shown), such as on the Internet. Images sent by the video conference server are received by the MGMS 100 and displayed on one of the television sets 118-122.

Although some embodiments of the MGMS 100 are capable of simultaneously providing several channels of video content over the in-home distribution medium 124, other embodiments of the MGMS include only one modulator. For example, a single PVR, such as a TiVo PVR, available from TiVo, Inc., Alviso, Calif., can be connected to a one-modulator MGMS. In this case, video contents recorded by the PVR are available for viewing on any of the television sets 118-122.

In addition, a single local video source 108 can provide multiple simultaneous video signals. For example, a PVR that can simultaneously play back multiple recorded programs can be connected to a multi-modulator MGMS. In this case, each television 118-122 can receive a different one of the recorded programs from the PVR.

A television set 118-122 that is capable of simultaneously receiving and displaying multiple channels, such as by a “picture-in-picture” facility, can simultaneously receive more than one of the channels placed on the distribution medium 124 by the MGMS 100.

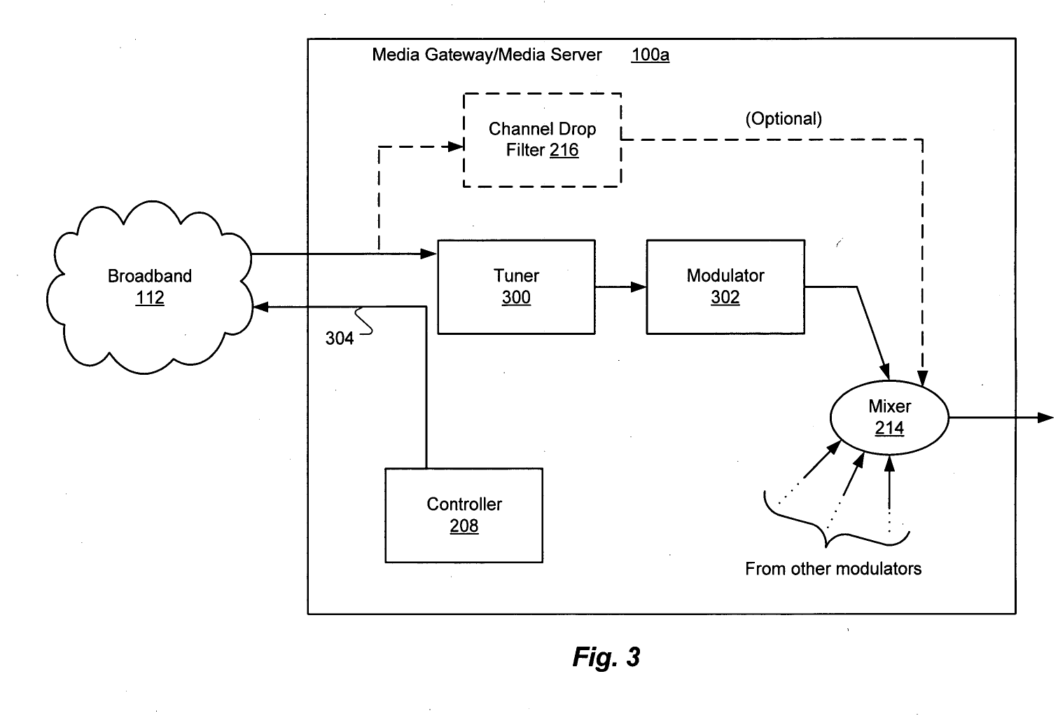

Alternatively, as shown in FIG. 3, an MGMS 100a includes one or more tuners 300 capable of receiving the channels of the broadband service 112. (Other portions of the MGMS 100a are similar to the MGMS 100 discussed above and are omitted for simplicity.) The tuner 300 is controlled by the controller 208. However, if the television sets 118-122 are capable of decoding a video signal according to the encoding technique used by the broadband service 112, the MGMS 100a need not include a decoder for the received signal. The encoded video signal provided by the tuner 300 is fed into a digital modulator 302, and the output of the modulator 302 is fed into the mixer 214. If the television sets 118-122 are not capable of decoding the video signal, a decoder (not shown) and an encoder (not shown) are included in the signal path between the tuner 300 and the digital modulator 302. Alternatively, a transcoder can be used in place of the decoder and the encoder.

If some or all of the received broadband service channels are encrypted, the MGMS 100a also includes a decrypter (not shown). Appropriate arrangements are made with the broadband carrier to provide decryption keys and permission to attach the MGMS 100a to the broadband system.

Optionally, the MGMS 100a includes a reverse channel 304 for communicating with a head end of the broadband system 112, such as to order pay-per-view video contents. This reverse channel 304 operates in the same manner as a reverse channel produced by a set-top-box.

Optionally, the MGMS 100a includes a channel drop filter 216. As discussed above, the channel drop filter 216 passes some of the channels of the broadband system 112 to the mixer 214, so cable-ready ones of the television sets 118-122 can tune in the unblocked channels directly, in addition to having the MGMS 100a re-modulate a selected broadband channel onto a reserved channel that is associated with this or another television set 112-122.

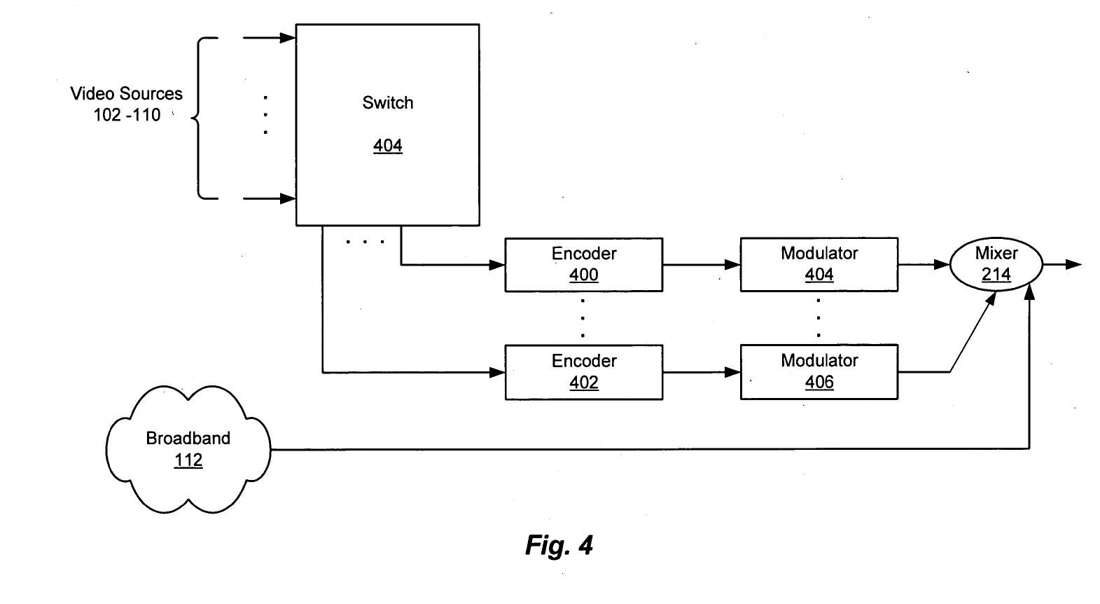

In some of the embodiments discussed thus far, each of the television sets 118-122 has been described as having an associated dedicated channel on the in-home distribution medium 124, and the MGMS 100 and 100a have been described as modulating selected video content onto the channel associated with the television set on which the video content is to be shown. However, channels need not be dedicated to the television sets 112-114. For example, as shown in FIG. 4, in another alternative MGMS 100b, each modulator 404, 406, etc. is statically assigned a reserved channel, and the television sets 118-122 dynamically tune to any of the reserved channels, depending on which video content is desired. The video sources 102-110 are each fed to an input port of a switch 404, outputs of which are fed to a bank of encoders 400, 402, etc. The outputs of the encoders 400, 402, etc. are fed to the modulators404, 406, etc., as described above.

The media gateway/media server thus exploits existing television sets'abilities to receive digitally modulated signals. Many channels of digitally modulated signals can be carried over a medium, such as an existing in-home coaxial cable and/or low-power over-the-air transmissions within a premises. One or more television sets can be connected to the medium. The media gateway/media server uses available ones of these channels to send video content to ones (or more) of the television sets connected to the medium. Thus, a central video library, stored on any combination of video devices (DVD players, personal computers, digital camera, the Internet, etc.) is accessible from any of the television sets. Consequently, purchase decisions regarding television sets can be made based on the quality of display and/or sound, esthetic qualities of the display panel and trim, etc., without regard to the number or type of video input ports.

Thus, disclosed herein are programmable and/or extensible devices capable of receiving video contents simultaneously from one or more sources, such as: servers or personal computers on a LAN or the Internet; multi-channel broadband terrestrial television broadcasts; multi-channel broadband carriers (such as CATV, DBS or telephone carrier system), which may also provide Internet access; a set-top-box receiving a single channel; or directly or indirectly connected video sources (such as a video, video conference or still digital camera; DVD; PVR; VCR; or PC). Some of these devices store, process, transform and/or generate video contents that have been received. The video contents can be stored: locally (i.e. within the devices); on a directly-attached mass storage device; on network attached storage or computer or servers on a LAN or the Internet.

Some of these devices receive the video contents in one format and decode and/or re-encode the video contents into another format. The video contents can be received by: streaming the contents from a server; or file transfer from a server. If the received video contents are protected, such as by encryption, the video may be decrypted before transmitting or storing them. Various segments of video contents may be combined or concatenated at the time they are stored or when they are sent to the television sets for viewing, such as to: insert commercial messages; stitch together portions (such as episodes) of the video contents to produce a continuous program; or present multiple content elements on a single screen (such as MGMS-generated picture-in-picture).

The devices send (transmit) video contents to one or more television sets in a digital form that does not require the use of an intervening device (such as a set-top-box) for the television sets to receive the contents. For example, the digital form can be ATSC, DVB, QAM or ISDB. The transmission can be over on-premises coaxial cable, with or without a conventional broadband signal. When needed, the devices include channel dropping filters to reserve one or more channels for use by the devices to transmit the video contents.

The devices receive information from, and optionally send information to, peripheral control devices over a variety of paths (such as wired or wireless LAN, infrared (IR), direct wireless RF link or cellular telephone link) to control operation of the devices, such as selecting video content to be displayed on a particular television set. The peripheral control devices include: IR remote control devices; portable, laptop, tablet, notebook, or non-portable computer; PDA; or smart phone. Optionally, video contents can be streamed to, and displayed on, the peripheral control device.

The devices cause video contents to be received from the video sources as a result of: direct request from a peripheral control device; predetermined time schedule; or locating appropriate video contents during a search of internally or externally stored video contents or consulting a database.

A media gateway/media server has been described as including a controller 208. The controller 208 and other portions of the MGMS include one or more processors controlled by instructions stored in one or more memories, such as random access memory (RAM), read-only memory (ROM), flash memory or any other memory suitable for storing control software or other instructions and data. Those skilled in the art should readily appreciate that finctions, operations, decisions, etc. of all or a portion of the controller 208 and other portions of the MGMS can be implemented as computer program instructions, software, hardware, firmware or combinations thereof. Those skilled in the art should also readily appreciate that instructions or programs defining the functions of the present invention can be delivered to a processor in many forms, including, but not limited to, information permanently stored on non-writable storage media (e.g. read only memory devices within a computer, such as ROM, or devices readable by a computer I/O attachment, such as CD-ROM disks), information alterably stored on writable storage media (e.g. floppy disks and hard drives) or information conveyed to a computer through communication media, including computer networks. In addition, while the invention may be embodied at least partially in software, the functions necessary to implement the invention may alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components. In particular, the modulators described above can be implemented as integrated circuits, combinations of integrated circuits or combinations of integrated circuits and discrete components. The encoders can also be implemented in such circuits, however software or firmware implementations might provide implementation advantages.

While the invention is described through the above-described exemplary embodiments, it will be understood by those of ordinary skill in the art that modifications to, variations of, combinations and sub-combinations of the illustrated embodiments may be made without departing from the inventive concepts disclosed herein. Accordingly, the invention should not be viewed as limited, except by the scope and spirit of the appended claims.

1. A video distribution system for displaying video content on at least one television set coupled to premises media, comprising:
a peripheral control device operative to select video content to be sent to the at least one television set; and
a media gateway comprising:
a premises media port for connection to said premises media and, thereby, to the at least one television set;
a first digital modulator operative to:
receive video content and to produce therefrom a first digitally modulated carrier signal that is directly receivable by the at least one television set; and
provide the first digitally modulated carrier signal to the premises media port;
a video source; and
a controller coupled to the first digital modulator and to the video source and operative to:
receive commands from the peripheral control device; and
upon receiving a command from the peripheral control device, cause at least some video content from the video source to be provided to the first digital modulator, such that the first digital modulator produces the first digitally modulated carrier signal from the at least some video content.

2. The video distribution system of claim 1, wherein the video source comprises an video source internal to the media gateway.

3. The video distribution system of claim 2, wherein the video source comprises a video game.

4. The video distribution system of claim 2, wherein the video source comprises a personal video recorder.

5. The video distribution system of claim 1, wherein the video source comprises at least one video input port for connection to a video source device.

6. The video distribution system of claim 5, wherein the at least one video input port comprises a computer network port for connection to a computer network on which the video content is stored.

7. The video distribution system of claim 5, wherein the at least one video input port comprises at least one digital video input port for connection to said video source device.

8. The video distribution system of claim 5, wherein the at least one video input port comprises at least one analog video input port for connection to said video source device.

9. The video distribution system of claim 5, wherein the at least one video input port comprises:
a computer network port for connection to a computer network; and
at least one digital video input port for connection to said video source device.

10. The video distribution system of claim 9, wherein the at least one video input port further comprises at least one analog video input port for connection to another video source device.

11. The video distribution system of claim 1, wherein the at least one television set has an associated channel and the media gateway is operative to send the first digitally modulated carrier signal to the at least one television set over the channel associated with the at least one television set.

12. The video distribution system of claim 1, wherein the media gateway further comprises an encoder in a signal path to the first digital modulator, such that the at least some of the received video content is provided to the encoder before being provided to the first digital modulator.

13. The video distribution system of claim 12, wherein the encoder is operative to encode the at least some of the received video content according to the Moving Picture Experts Group 2 (MPEG-2) encoding and encapsulation standard.

14. The video distribution system of claim 1, wherein the media gateway further comprises a transcoder in a signal path to the first digital modulator, such that the at least some of the received video content is provided to the transcoder before being provided to the first digital modulator.

15. The video distribution system of claim 1, further including a storage device, wherein:
the storage device is in communication with the controller and operative to store at least some of the video content; and
the controller is further operative, upon receiving a command from the peripheral control device, to cause at least some of the stored video content to be provided to the first digital modulator, such that the first digital modulator produces the first digitally modulated carrier signal from the at least some of the stored video content.

16. The video distribution system of claim 15, wherein the storage device is connected to the media gateway via a computer network.

17. The video distribution system of claim 15 further including a computer distinct from the media gateway, wherein the storage device is connected to, and controlled by said computer distinct from the media gateway, and the computer is connected to the media gateway via a computer network.

18. The video distribution system of claim 15, wherein the storage device is internal to the media gateway.

19. The video distribution system of claim 1, wherein the first digitally modulated carrier signal produced by the digital modulator is an Advanced Television Systems Committee (ATSC) signal.

20. The video distribution system of claim 1, wherein the first digitally modulated carrier signal produced by the digital modulator is a Digital Video Broadcasting (DVB) signal.

21. The video distribution system of claim 1, wherein the first digitally modulated carrier signal produced by the digital modulator is a Integrated Services Digital Broadcasting (ISDB) signal.

22. The video distribution system of claim 1, wherein the first digitally modulated carrier signal produced by the digital modulator is an vestigial sideband (VSB) signal.

23. The video distribution system of claim 1, wherein the first digitally modulated carrier signal produced by the digital modulator is an 8-level vestigial sideband (8-VSB) signal.

24. The video distribution system of claim 1, wherein the first digitally modulated carrier signal produced by the digital modulator is a 16-level vestigial sideband (16-VSB) signal.

25. The video distribution system of claim 1, wherein the first digitally modulated carrier signal produced by the digital modulator is a quadrature amplitude modulation (QAM) signal.

26. The video distribution system of claim 1, wherein the first digitally modulated carrier signal produced by the digital modulator is a 64 constellation point quadrature amplitude modulation (64-QAM) signal.

27. The video distribution system of claim 1, wherein the first digitally modulated carrier signal produced by the digital modulator is a 256 constellation point quadrature amplitude modulation (256-QAM) signal.

28. The video distribution system of claim 1, wherein the media gateway further comprises:
a broadband port for connection to a broadband television distribution system having a plurality of channels; and
a mixer coupled to the broadband port and to the first digital modulator and operative to combine at least a portion of the plurality of channels from the broadband television distribution system and the first digitally modulated carrier signal from the first digital modulator and to provide a combined signal to the at least one television set.

29. The video distribution system of claim 28, further comprising:
a channel drop filter before the mixer and operative to block a subset of the plurality of channels from the broadband television distribution system and allow unblocked channels from the broadband television distribution system to pass through to the mixer;
wherein the first digital modulator produces the first digitally modulated carrier signal on at least one of the blocked channels.

30. The video distribution system of claim 28, wherein the broadband television distribution system includes a set-top-box operative to provide an interface to a multi-channel media distribution system, and the media gateway further comprises a port for controlling the set-top-box.

31. The video distribution system of claim 1, wherein the media gateway further comprises:
a second digital modulator coupled to the controller and operative, upon the media gateway receiving a command from the peripheral control device, to receive second video content and to produce therefrom a second digitally modulated carrier signal that is directly receivable by the at least one television set, the second digitally modulated carrier signal being produced on a different channel than the first digitally modulated carrier signal; and
a mixer coupled to the first and second digital modulators and operative to combine the first and second digitally modulated carrier signals and to provide a combined signal to the premises media port.

32. The video distribution system of claim 31, wherein the media gateway further comprises:
a broadband port for connection to a broadband television distribution system having a plurality of channels;
wherein the mixer is also coupled to the broadband port and operative to combine at least a portion of the plurality of channels from the broadband television distribution system and the first and second digitally modulated carrier signals and to provide a combined signal to the premises media port.

33. The video distribution system of claim 32, further comprising:
a channel drop filter before the mixer and operative to block at least two of the plurality of channels from the broadband television distribution system and allow unblocked channels from the broadband television distribution system to pass through to the mixer;
wherein the first and second digital modulators produce the first and second digitally modulated carrier signals on at least respective ones of the blocked channels.

34. The video distribution system of claim 1, wherein the peripheral control device is operative to communicate with the controller over a wireless link.

35. The video distribution system of claim 34, wherein the peripheral control device is operative to communicate directly with the controller over the wireless link.

36. The video distribution system of claim 34, wherein the peripheral control device is operative to communicate indirectly with the controller via another device.

37. The video distribution system of claim 36, wherein the peripheral control device is operative to communicate indirectly with the controller via a reverse channel between one of the at least one television set and the media gateway.

38. The video distribution system of claim 1, wherein the peripheral control device is operative to communicate with the controller over a local area computer network.

39. The video distribution system of claim 38, wherein the peripheral control device comprises a personal computer.

40. The video distribution system of claim 38, wherein the peripheral control device comprises a tablet computer.

41. The video distribution system of claim 38, wherein the peripheral control device comprises a personal digital assistant.

42. The video distribution system of claim 1, wherein the peripheral control device comprises a smart phone.

43. The video distribution system of claim 1, wherein the video source comprises a plurality of video sources, wherein, upon receiving a command from the peripheral control device, the controller is operative to select one of said plurality of video sources and to provide video content from the selected one of the plurality of video sources to the first digital modulator, such that the first digital modulator produces the first digitally modulated carrier signal from the video content from the selected one of the plurality of video sources.

44. The video distribution system of claim 43, wherein at least some of the plurality of video sources are digital video sources.

45. The video distribution system of claim 43, wherein at least some of the plurality of video sources are analog video sources.

46. The video distribution system of claim 43, wherein at least some of the plurality of video sources are digital video sources and other of the plurality of video sources are analog video sources.

47. The video distribution system of claim 1, further comprising a premises coaxial cable connected to the premises media port and interconnecting the media gateway and the at least one television set, the premises coaxial cable being operable to transport the first digitally modulated carrier signal from the media gateway to the at least one television set.

48. The video distribution system of claim 1, wherein the premises media port comprises a wireless transmitter operable to transmit the first digitally modulated carrier signal to the at least one television set.

49. A method for distributing video signals to a plurality of television sets, comprising:
associating a first channel of an in-premises medium with at least one of the plurality of television sets;
responsive to a command from a peripheral control device, selecting video content;
producing, from the selected video content, a digitally modulated carrier signal, on the first channel, that is directly receivable on the plurality of television sets; and
distributing the digitally modulated carrier signal via the in-premises medium to the plurality of television sets.

50. The method of claim 49, further comprising encoding the selected video content before producing the digitally modulated carrier signal.

51. The method of claim 49, further comprising transcoding the selected video content before producing the digitally modulated carrier signal.

52. The method of claim 49, further comprising storing the selected video content until receipt of a command from the peripheral control device and then producing the digitally modulated carrier signal.

53. The method of claim 49, further comprising:
blocking at least one channel of a broadband television system and passing unblocked channels of the broadband television system to the in-premises medium;
wherein the first channel is one of the at least one blocked channel.

54. The method of claim 49, further comprising:
associating a second channel, different than the first channel, of the in-premises medium with a different at least one of the plurality of television sets;
selecting second video content;
producing, from the selected second video content, a second digitally modulated carrier signal, on the second channel, that is directly receivable on the plurality of television sets; and
distributing the second digitally modulated carrier signal via the in-premises medium to the plurality of television sets.

55. The method of claim 54, further comprising:
blocking at least two channels of a broadband television system and passing unblocked channels of the broadband television system to the in-premises medium;
wherein the first and second channels of the digitally modulated carrier signals produced from the selected video content are ones of the at least two blocked channels.

56. The method of claim 49, wherein distributing the digitally modulated carrier signal via the in-premises medium comprises distributing the digitally modulated carrier signal via a coaxial cable.

57. The method of claim 49, wherein distributing the digitally modulated carrier signal via the in-premises medium comprises wirelessly transmitting the digitally modulated carrier signal.

58. The method of claim 49, wherein selecting the video content comprises selecting the video content received via a computer network from a storage location on the computer network.

59. The method of claim 49, wherein selecting the video content comprises selecting the video content received from a directly connected video source device.

60. The method of claim 49, wherein selecting the video content comprises selecting the video content received from a directly connected set-top-box.

61. A media gateway for distributing video content over premises media to at least one television set in response to a command from a peripheral control device, comprising:
a premises media port for connection to the premises media and, thereby, to the at least one television set;
at least one video input port for connection to a respective video source;
a digital modulator operative to:
receive video content from the at least one video input port and to produce therefrom a first digitally modulated carrier signal that is directly receivable by the at least one television set; and
provide the first digitally modulated carrier signal to the premises media port; and
a controller coupled to the digital modulator and to the at least one video input port and operative to:
receive commands from the peripheral control device;
cause one of the at least one video input port to receive the video content from the respective video source; and
upon receiving a command from the peripheral control device, cause at least some of the received video content to be provided to the digital modulator, such that the digital modulator produces the first digitally modulated carrier signal from the at least some of the received video content.

62. The video distribution system of claim 1, wherein the media gateway further comprises:
a broadband port for connection to a broadband television distribution system having a plurality of channels; and
wherein the video source comprises a tuner coupled to the broadband port and operative, in response to a command from the peripheral control device, to receive at least a selected one of the plurality of channels of the broadband television distribution system and provide video content from the received channel to the digital modulator.

63. The video distribution system of claim 62, wherein the video source further comprises a video game internal to the media gateway.

64. The video distribution system of claim 62, wherein the video source further comprises a personal video recorder internal to the media gateway.

65. The video distribution system of claim 62, wherein the video source further comprises a video input port for connection to an external video source device.

66. The video distribution system of claim 62, further comprising a decrypter coupled to the tuner and operative to decrypt at least some of the video content from the received channel.

67. The video distribution system of claim 62, further comprising a mixer coupled to the broadband port and to the digital modulator and operative to combine at least a portion of the plurality of channels from the broadband television distribution system and the first digitally modulated carrier signal from the digital modulator and to provide a combined signal to the premises media port.

68. The video distribution system of claim 67, further comprising a channel drop filter between the broadband port and the mixer and operative to block a subset of the plurality of channels from the broadband television distribution system and allow unblocked channels from the broadband television distribution system to pass through to the mixer; wherein the digital modulator produces the first digitally modulated carrier signal on at least one of the blocked channels.

69. The video distribution system of claim 62, wherein the controller is further operative to communicate with the broadband television distribution system to request video content.
